(19) United States
(12) Patent Application Publication
(10) Pub. No.: US 2008/0178261 A1
(43) Pub. Date: Jul. 24, 2008

(54) Information processing apparatus

(76) Inventors: Hiroshi Yao, Kanagawa (JP); Tatsunori Kanai, Kanagawa (JP); Kenichiro Yoshii, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/896,861

(22) Filed: Sep. 6, 2007

(30) Foreign Application Priority Data
Jan. 19, 2007 (JP) 2007-010444

(51) Int. Cl. G06F 17/30

(52) U.S. Cl. 726/2

(57) ABSTRACT

An information processing apparatus includes a storage unit, a processor, a channel, a detecting unit, and a control unit. The storage unit stores therein privilege software that is allowed to access a first access range. The processor executes the privilege software and software that is allowed to access a second access range. The channel connects the storage unit and the processor. The detecting unit detects a fetch request that is issued by the processor through the channel and specifies an address at which the privilege software is stored. The control unit controls an access range of the processor based on whether the fetch request is detected.

### CROSS-REFERENCE TO RELATED APPLICATIONS

This application is based upon and claims the benefit of priority from the prior Japanese Patent Application No. 2007-010444 filed on Jan. 19, 2007; the entire contents of which are incorporated herein by reference.

### BACKGROUND OF THE INVENTION

1. Field of the Invention

The present invention relates to an information processing apparatus that controls access of software.

2. Description of the Related Art

Database systems and server machines that execute mission-critical processing have been required to ensure reliability and security because of importance of the processing and confidentiality of data held in the database systems and the server machines. In recent years, ensuring of reliability and security is important not only in such general-purpose computers but also various systems such as embedded systems.

In the embedded systems, functions are becoming complicated. For example, a plurality of functions is simultaneously performed in one apparatus, and new functions are downloaded and added. In development or operation of such apparatuses capable of performing a plurality of functions, new problems are arising compared with single-function apparatuses.

For example, when a function has a defect, even if the function is only a part of functions of an apparatus, the entire apparatus may hang up. When a function downloaded and added to an apparatus is a malicious and illegal computer program, confidential information or a computer program may be leaked to the outside and destroyed or altered. Therefore, reliability and security are important in embedded systems and the like as well.

To solve the problem, it is necessary to control access to resources allocated to programs that realize functions. For example, it is conceivable to deny access to a resource allocated to a certain program from other programs or exclusively control and manage access to a resource shared by a plurality of functions and programs. Moreover, it is necessary to protect an access control mechanism and control information itself to make it impossible to freely operate the access control mechanism and the control information.

As means for realizing such protection and isolating a plurality of functions to improve reliability and security, a virtualization technique for computers is proposed. There are various forms as implementation of this virtualization technique. As an example of the virtualization technique, there is a form of providing a virtualization layer between hardware and an operating system (OS) to cause a plurality of OSs (guest OSs) to run on the virtualization layer. This virtualization layer is generally called a hypervisor layer. This hypervisor layer manages resources such as memories, devices, and interrupts and provides a virtual machine including resources allocated to the respective guest OSs. This makes it possible to realize execution of the functions in a state in which the guest OSs are isolated and do not interfere with one another. When the functions of the hypervisor layer are realized by software, the software is called hypervisor.

In a processor used in the general-purpose computers, a hardware mechanism for supporting virtualization is prepared in the processor itself. For example, Intel Corporation has proposed a technology in “Intel® Virtualization Technology Specification for the IA-32 Intel® Architecture”, [online], [searched on May 31, 2005], Internet <URL:ftp://download.intel.com/technology/computing/vptech/C97063-002.pdf>. In a processor implemented with this technology, A processor with this technology provides two sets of modes (root operation and non-root operation) indicating authorities of programs being executed, and it is possible to shift to a high-order privilege mode (root operation) when a specific instruction is executed and shift to a higher-order privilege mode when a specific instruction is executed. This makes it possible to monitor access from guess OSs to a shared resource with hardware and, at the time of access, check contents of the access with software to which a high-order privilege mode is given.

As another example, there is a technology (Pacifica) proposed by Advanced Micro Devices, Inc. In a processor implemented with the technology (Pacifica), a mechanism for intercepting an interrupt and a function for causing software to generate a virtual interrupt are prepared. This makes it possible to manage, after once intercepting an interrupt in a hypervisor, interrupt delivering to a guest OS that requires the interrupt. A mechanism for monitoring access to an address translation table by the guest OS is prepared. This makes it possible to prevent the guest OS from freely rewriting the address translation table and accessing memory areas allocated to the other guest OSs.

However, unlike advanced processors used in the general-purpose computers, a mechanism for supporting virtualization is not implemented in processors generally used for embedded systems. Usually, in these processors, since there are only a few privilege modes, when a plurality of guest OSs is executed in the processors, the respective guest OSs operate in a highest-order privilege mode. Therefore, an arbitrary guest OS is capable of illegally referring to and changing memory areas and devices allocated to the other guest OSs. Further, since the processors do not have a mechanism for protecting an interrupt vector table for managing interrupts, it is not guaranteed that a hypervisor can surely perform intercept and transfer of an interrupt.

### SUMMARY OF THE INVENTION

According to an aspect of the present invention, an information processing apparatus includes a storage unit that stores therein first software that is allowed to access a first access range, a processor that executes the first software and second software that is allowed to access a second access range narrower than the first access range, a channel connecting the storage unit and the processor for communicating data to execute the first software on the processor, a detecting unit that detects a fetch instruction that is issued by the processor through the channel and specifies a storage address in the storage unit at which the first software is stored, and a control unit that controls an access range of the processor based on whether the fetch instruction is detected.

### BRIEF DESCRIPTION OF THE DRAWINGS

FIG. 1 is a block diagram of a system large scale integration (LSI) according to a first embodiment of the present invention;

FIG. 2 is a schematic diagram for explaining an example in which, during execution of a hypervisor on a conventional processor, an illegal software code is executed;

FIG. 3 is an example of a source of an HV code in the system LSI shown in FIG. 1;

FIG. 4 is an example of a software configuration of the system LSI shown in FIG. 1;

FIG. 5 is a flowchart of a processing procedure for setting control information according to transition of operation mode in the system LSI shown in FIG. 1;

FIG. 6 is a detailed flowchart of a processing procedure of HV-mode entry detection shown in FIG. 5;

FIG. 7 is a detailed flowchart of a processing procedure of HV-mode exit detection shown in FIG. 5;

FIG. 8 is a block diagram of a system LSI according to a second modification of the first embodiment;

FIG. 9 is a block diagram of a system LSI according to a second embodiment of the present invention;

FIG. 10 is an example of a source of an HV code stored in a memory connected to the system LSI shown in FIG. 9;

FIG. 11 is an example of addresses in an HV-code storage area in the memory connected to the system LSI shown in FIG. 9;

FIG. 12 is a flowchart of a processing procedure of HV-mode entry detection according to the second embodiment;

FIG. 13 is a flowchart of a processing procedure of HV-mode exit detection according to the second embodiment; and

FIG. 14 is a block diagram of a system LSI as a modified example.

### DETAILED DESCRIPTION OF THE INVENTION

Exemplary embodiments of the present invention are explained in detail below with reference to the accompanying drawings. In the following description, an information processing apparatus of the embodiments is applied to a system large scale integration (LSI). However, the information processing apparatus can be applied to apparatuses other than a system LSI.

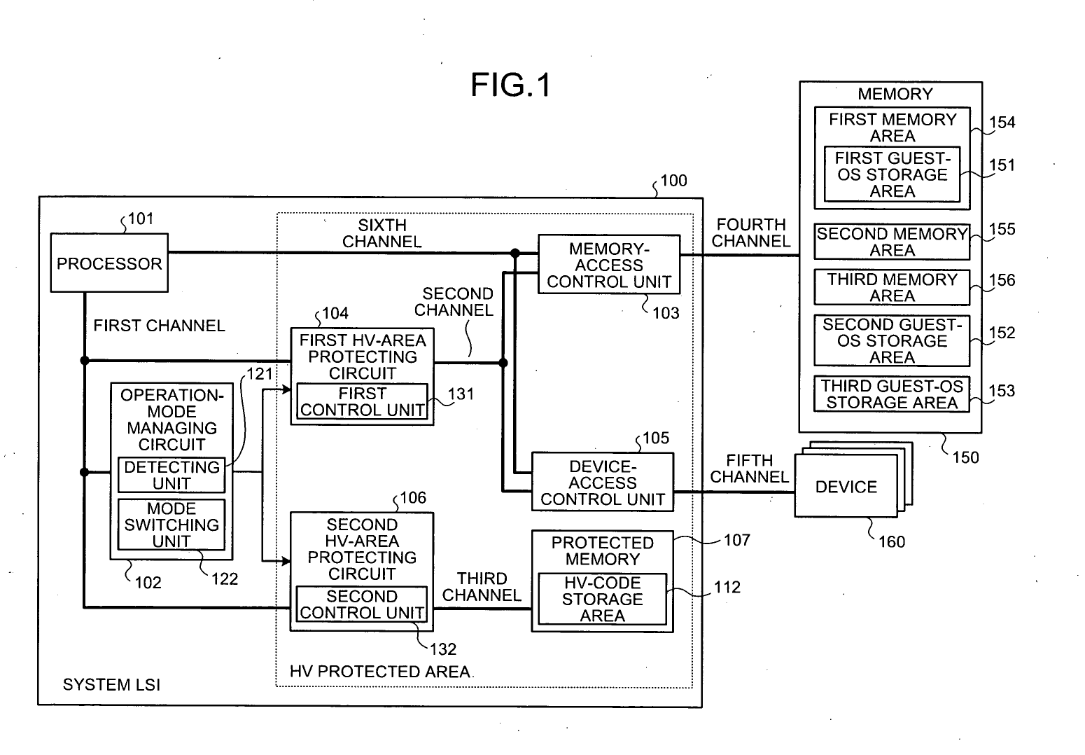

As shown in FIG. 1, a system LSI 100 according to a first embodiment of the present invention connects a memory 150 and a device 160. The system LSI 100 includes a processor 101, an operation-mode managing circuit 102, a memory-access control unit 103, a first hypervisor (HV)-area protecting circuit 104, a device-access control unit 105, a second HV-area protecting circuit 106, and a protection memory 107.

The system LSI 100 includes first to sixth channels. These channels are media for communicating data between the processor 101 and the memory, the device, and the like. At least an address of an access destination and data read and written are sent via the channels. The channels may take any form and, in this embodiment, buses are used as the channels. As examples of the buses, it is conceivable that the buses include an address bus equivalent to a bit width of an address, a data bus equivalent to a bit width of data, and a control line indicating reading and writing. As another example, like a serial bus, the buses may include a small number of control lines through which an access request from a processor and a response from a memory are exchanged in a predetermined protocol.

In the system LSI 100, when privilege software is running on the processor 101, the privilege software is set to run in a highest-order operation mode managed by the system LSI 100. Only in the highest-order operation mode, predetermined access to an HV protection area is permitted.

The privilege software must not be tampered with. In this embodiment, the privilege software is stored in the protected memory 107 for which reading and writing are restricted. In this embodiment, as an example, a hypervisor is used as the privilege software. In the hypervisor, all access destinations included in an HV protection area described later are an access (accessible) range. A source code of the hypervisor is referred to as “HV code”. The highest-order operation mode is referred to as “HV mode”.

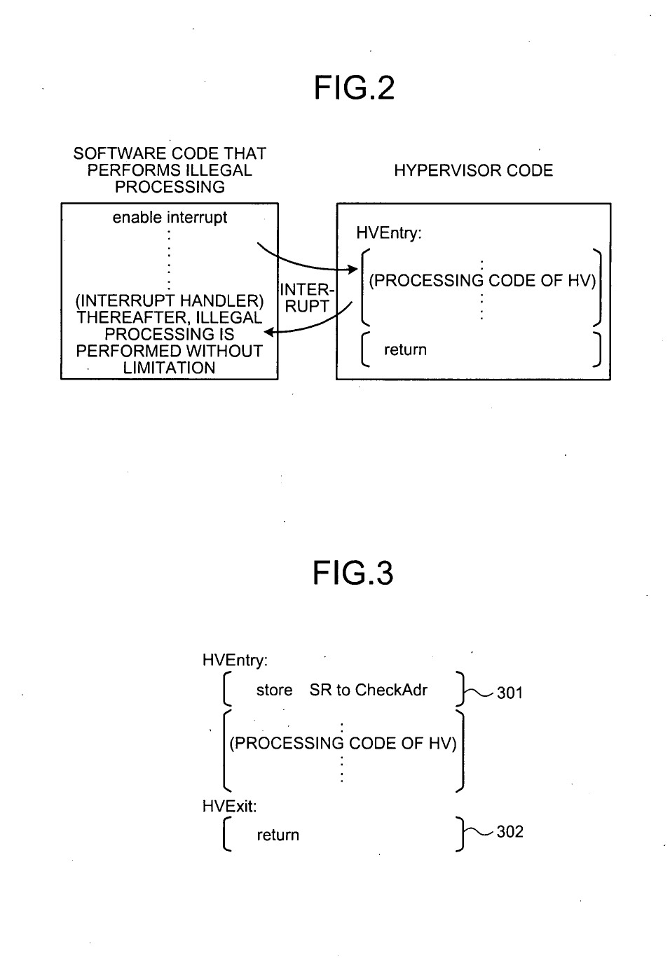

In the case that operation mode is simply designed to change into highest-order operation mode at the time of entering the hypervisor, software other than hypervisor happens to be run in highest-order operation mode. The example of this inappropriate situation is described first using FIG. 2. In FIG. 2, a source code on the left side is a software code for performing illegal processing and a source code on the right side is a source code of the hypervisor (HV code). In software that performs illegal processing, a processor is set to interrupt enable according to “enable interrupt”. Thereafter, at the time of execution of the software for performing illegal processing, processing jumps to an entry section of the HV code. At the same time, the operation mode is changed to the highest-order operation mode.

When the processor is interrupt enable during execution of the HV code, if an interrupt by another type of software occurs, the processing jumps to an interrupt processing routine while the highest-order operation mode is set. When it is possible to completely protect an interrupt vector and the interrupt processing routine as in a processor used for a general-purpose computer, even if such jump to the interrupt processing routine is performed, no problem occurs if the software code is described such that the processor returns to the HV code again. However, in a processor used in a embedded system, it is impossible to completely place the interrupt vector table and the interrupt processing routine under the protection of the hypervisor. Therefore, it is likely that an arbitrary code is executed when an interrupt occurs.

As means for coping with such an illegal act, the highest-order operation mode only has to be set only during execution of the HV code. Specifically, it is conceivable to, when a instruction is fetched from the storage area in which the hypervisor is stored, cause transition of an operation mode such that the hypervisor operates in the highest-order operation mode. However, when processing jumps from arbitrary software to the middle of the hypervisor, regardless of the fact that the operation mode transits to the highest-order operation mode, it is impossible to guarantee that the hypervisor code operates correctly. When an interrupt occurs, the execution of the HV code is still interrupted. Thus, in this embodiment, such a problem is solved by realizing a configuration and processing described below.

The memory 150 includes a first memory area 154, a second memory area 155, a third memory area 156, a second guest-OS storage area 152, and a third guest-OS storage area 153. The first memory area 154 holds a first guest-OS storage area 151.

A code of a first guest OS is stored in the first guest-OS storage area 151. A code of a second guest OS is stored in the second guest OS storage area 152. A code of a third guest OS is stored in the third guest-OS storage area 153. The first memory area 154, the second memory area 155, and the third memory area 156 are storage areas for which reading and writing are restricted by the memory-access control unit 103. An area that stores a guest OS may be secured in a storage area for which reading and writing are restricted like the first guest-OS storage area 151.

The device 160 is a device connected to the system LSI 100 and controlled by the processor included in the system LSI 100. Access of the device 160 is restricted by the device-access control unit 105 described later. The device 160 may be included in the system LSI 100 or may be provided outside the system LSI 100. The number of devices connected to the system LSI 100 is not specifically restricted.

As examples of the device 160, a memory module, a external mass storage such as a hard disk, an external communication device such as a network interface, an input device, such as a keyboard or a mouse, through which a user provide input, and an external output device such as a display are conceivable. However, the device 160 is not restricted to these devices.

The processor 101 performs processing, an arithmetic operation, and the like according to an OS such as the first guest OS and software such as the hypervisor. The processor 101 does not have a function for supporting virtualization built therein.

The processor 101 sequentially reads instructions from memories (the memory 150 and the protection memory 107) and executes the instructions. The processor 101 reads data from and writes data to the memories and the devices connected to the channels according to the instructions.

Thus, in this embodiment, an HV mode that is an operation mode having an access authority higher in order than an operation mode held by the processor 101 is introduced. Therefore, the operation mode is switched to the HV mode by hardware arranged outside the processor 101. In this case, since jump to the HV code, shift to the interrupt disable state, are operations in the processor 101, it is impossible to control the operations from the hardware arranged on the outside.

Thus, in the system LSI 100, the jump to the HV code and the shift to the interrupt disable state are left to the software (e.g., the first guest OS) running on the processor 101 and the hardware outside the processor 101 checks whether the processing appropriately jumps to the HV code and is appropriately set in the interrupt disable state.

The operation-mode managing circuit 102 includes a detecting unit 121 and a mode switching unit 122. The operation-mode managing circuit 102 monitors data transmitted through the first channel, which connects the processor 101 and the second HV-area protecting circuit 106, and switches the operation mode as required.

The operation-mode managing circuit 102 is a state transition circuit that holds at least two states of an HV mode and a normal mode as operations modes. The operation-mode managing circuit 102 monitors a signal flowing through the first channel and, when predetermined conditions are satisfied, causes a state transition between the HV mode and the normal mode. The operation-mode managing circuit 102 outputs a mode information signal to the first HV-area protecting circuit 104 and the second HV-area protecting circuit 106 according to the state of the HV mode or the normal mode. Consequently, the first HV-area protecting circuit 104 and the second HV-area protecting circuit 106 can perform access control corresponding to the operation mode. Details concerning operations of the operation-mode managing circuit 102 are described later.

Processing required to be performed by the operation-mode managing circuit 102 to switch the operation mode to the HV mode is processing for shifting execution to an entry section of the HV code (i.e., it is necessary to guarantee that the execution is shifted) and processing for setting the processor 101 in the interrupt disable state (i.e., it is necessary to guarantee that the processor is in the interrupt disable state). The operation-mode managing circuit 102 can perform processing for setting the operation mode in the HV mode after guaranteeing execution of these two types of processing. In other words, these three types of processing are required to be inseparably performed. This means that another type of processing is not performed during these types of processing. Naturally, the HV code needs to be protected against updates by other software such as a guest OS.

The operation-mode managing circuit 102 manages the operation mode by performing the processing to satisfy the conditions. Consequently, when the operation-mode managing circuit 102 switches the operation mode to the HV mode, it is guaranteed that only the HV code is executed. In an HV protection area described later, the first HV-area protecting circuit 104 and the second HV-area protecting circuit 106 described later perform processing for changing accessible range on the memory 150 and the protection memory 107 and an address range in the device 160. The access range indicates a range of access destinations to which access is permitted.

Consequently, only at the time of execution of the HV code, only the hypervisor is permitted to access all the access destinations included in the HV protection area. In the case of the normal mode, the first guest OS and the like are permitted to access an access range narrower than (a range of) all the access destinations included in the HV protection area.

The processing for shifting execution to the HV code and the processing for setting the processor 101 in the interrupt disable state are performed by the software running on the processor 101. The operation-mode managing circuit 102 detects an execution request or an execution result of these types of processing. As a method of checking the detection, the operation-mode managing circuit 102 monitors the type of an access request, an address, and data sent and received through the first channel that connects the processor 101 and the protection memory 107.

The detecting unit 121 detects, for example, fetch of a instruction for a predetermined address of the HV code stored in an HV-code storage area 112 of the protection memory 107 described later via the first channel, which connects the processor 101 and the second HV-area protecting circuit 106. Detailed processing is described later.

The mode switching unit 122 switches the operation mode according to a detection result of the detecting unit 121. For example, when the detecting unit 121 detects fetch of a instruction for an HV entry indicating the entry section of the HV code, the mode switching unit 122 switches the operation mode to the HV mode considering that the hypervisor runs on the processor 101.

When the detecting unit 121 detects fetch of a instruction for an HV exit indicating an exit section of the HV code, the mode switching unit 122 switches the operation mode to the normal mode considering that the software such as the first guest OS runs on the processor 101. Detailed switching conditions and the like are described later.

In this embodiment, in the system LSI 100, an area for which a change and the like of a range is performed as an access destination according to software running on the processor 101 is set as a hypervisor (HV) protection area. As shown in FIG. 1, the HV protection area includes the memory-access control unit 103, the device-access control unit 105, the protection memory 107, the first hypervisor (HV)-area protecting circuit 104, and the second HV-area protecting circuit 106.

Concerning access (reading and writing) from the processor 101, predetermined restriction is set on the components (the memories and the circuits) stored in the HV protection area. Consequently, control information concerning the memories and the devices stored in the HV storage area, management information concerning guest OS, and the like are accessible and writable only in the HV code. Thus, it is possible to protect the control information, the management information, and the like from illegal processing by the guest OS and the like.

In this embodiment, the components described above are included in the HV protection area. However, components included in the HV protection area are not limited to these components. As a modification, an HV protection area of a system LSI may include only an HV-area protecting circuit and a memory-access control unit, may include only an HV-area protecting circuit and a device-access control unit, may include only an HV-area protecting circuit and a protection memory, or may include a combination of two or more of these devices. A detailed example of other combinations is described later.

The protection memory 107 stores the HV-code storage area 112. The protection memory 107 is write-protected in the case of the normal mode.

The HV-code storage area 112 stores the HV code. As shown in FIG. 3, the HV code holds “store SR to CheckAdr” in the entry section 301 and holds “return” in the exit section 302.

The HV code stored in the HV-code storage area 112 should not be corrected by software such as guest OSs. In this embodiment, the HV code is protected by the second HV-area protecting circuit 106. As another example, the HV-code storage area 112 may be provided on a read only memory (ROM) unrewritable from the processor 101.

In this embodiment, the HV-code storage area 112 is provided in the protection memory 107 provided in the HV protection area. Writing in the HV-code storage area 112 is denied by the second HV-area protecting circuit 106 when the operation mode is other than the HV mode. This makes it possible to prevent correction of the HV code from the guest OSs. In this embodiment, the HV-code storage area 112 is provided in the HV protection area. However, the HV-code storage area 112 may be provided anywhere as long as correction of the HV code can be prevented from the guest OSs. For example, the HV-code storage area 112 may be provided in the memory 150 (however, when the HV-code storage area 112 is provided in the memory 150, it is necessary to connect the operation-mode managing circuit 102 to the channel 6).

Moreover, the second HV-area protecting circuit 106 may perform control not only to deny writing in the HV-code storage area 112 but also to prohibit all kinds of operation for addresses of an HV code body excluding the entry section of the HV code. When the second HV-area protecting circuit 106 performs control in this way, it is also possible to prevent reading of the HV code body in the normal mode. This makes it possible to conceal processing contents of the HV code from the guest OSs and further improve safety.

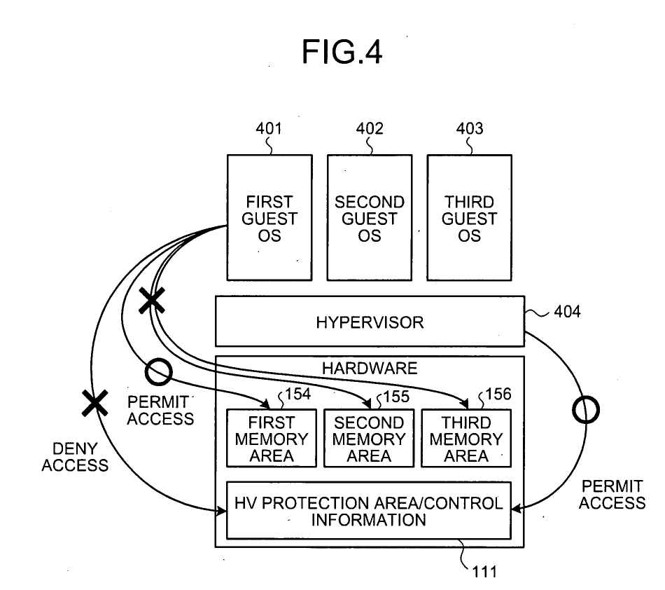

As shown in FIG. 4, in the system LSI 100, a hypervisor 404 is arranged on hardware as a lowest layer of software. A first guest OS 401, a second guest OS 402, and a third guest OS 403 are arranged on the hypervisor 404. In FIG. 4, for simplicity of explanation, the first memory area 154, the second memory area 155, and the third memory area 156 in the memory 150 and control information stored in the memory-access control unit 103 and the device-access control unit 105 of the HV protection area 111 are shown as hardware. However, the same control is performed even if other components are included in the hardware.

The hypervisor 404 provides a function for switching the guest OSs 401 to 403. In the system LSI 100, at the time of switching of the guest OSs, after returning processing from the guest OS to the hypervisor, saving of a state of the present guest OS and reset of a state of the next guest OS are performed.

When the processing is shifted from the guest OS to the hypervisor, the operation mode changes to the HV mode. At this point, the hypervisor can update control information that is referred to when the memory-access control unit 103 and the device-access control unit 105 perform control. Thus, the hypervisor updates the control information to allow only a memory and a device allocated to the next guest OS to access the control information. In this way, the hypervisor running in the HV mode can access all types of hardware (access destinations) included in the HV protection area.

At a stage when the processing shifts from the hypervisor to the next guest OS, the operation mode changes to the normal mode. In the normal mode, it is impossible to update the control information. Consequently, the memory-access control unit 103 can permit the first guest OS 401 to access only the first memory area 154 and prohibit the first guest OS 401 from accessing the second memory area 155 and the third memory area 156. Consequently, in the system LSI 100, it is possible to prevent an illegal guest OS from accessing memories and devices allocated to the other guest OSs. In a software configuration of the system LSI 100, a plurality of guest OSs operates apart from one another.

Referring back to FIG. 1, the second HV-area protecting circuit 106 is arranged between the protection memory 107 and the processor 101 and performs processing for protecting the protection memory 107. In this embodiment, the processor 101 and the second HV-area protecting circuit 106 are connected by the first channel and the second HV-area protecting circuit 106 and the protection memory 107 are connected by the third channel. A mode information signal indicating an operation mode is input to the second HV-area protecting circuit 106 from the operation-mode managing circuit 102.

The second HV-area protecting circuit 106 includes a second control unit 132 and receives an access request from the processor 101 via the first channel. When the mode information signal received from the operation-mode managing circuit 102 is a value indicating the HV mode, the second HV-area protecting circuit 106 outputs the access request to the protection memory 107 via the third channel.

When the mode information signal indicates that the operation mode is the HV mode, the second control unit 132 performs control for permitting an access request to the protection memory 107. When the mode information signal indicates that the operation mode is the normal mode, the second control unit 132 performs control for denying an access request to the protection memory 107.

Consequently, when the mode information signal has a value indicating the operation mode other than the HV mode, the second HV-area protecting circuit 106 is prevented from outputting the access request to the protection memory 107. As an example of the restriction on access to the protection memory 107, access to a part of addresses in the protection memory 107 is denied or only writing in the protection memory 107 is denied. These restrictions may be combined. Such restrictions are effective when access to only a part of the protection memory 107 is restricted at the time of the normal mode and when operation of a part of the protection memory 107 is denied (denial of only writing, etc.).

When the HV code is concealed, the second HV-area protecting circuit 106 makes it possible to always read out only an address corresponding to the entry section of the HV code in the HV-code storage area 112. The second HV-area protecting circuit 106 makes it possible to read out an address corresponding to the body of the HV code only at the time of the HV mode. A procedure for changing the operation mode to the HV mode at the time of execution of the HV code is explained later. By performing such processing, it is possible to further improve safety.

In this embodiment, the protection memory 107 and the second HV-area protecting circuit 106 are separate components. However, the functions of these devices may be arranged in the system LSI 100 as one component.

The first HV-area protecting circuit 104 includes a first control unit 131 and receives an access request from the processor 101 via the first channel. The first HV-area protecting circuit 104 connects the memory-access control unit 103 and the device-access control unit 105 via the second channel. The first HV-area protecting circuit 104 receives a mode information signal from the operation-mode managing circuit 102.

The memory-access control unit 103 and the memory 150 are connected by the fourth channel and the device 160 and the device-access control unit 105 are connected by the fifth channel.

The memory-access control unit 103 controls access to the memory 150. The system LSI 100 includes a sixth channel as a channel that connects the processor 101 and the memory-access control unit 103. The first channel and the second channel are prepared as channels for accessing control information in the memory-access control unit 103 from the processor 101. Consequently, an access request to the memory 150 is output via the sixth channel. The same channels are provided for the device-access control unit 105.

The memory-access control unit 103 permits access (at least writing or both writing and reading) to a predetermined address of control information from the processor 101 via the first channel and the first HV-area protecting circuit 104. In the memory access control unit 103, this control information is a protection object.

The memory-access control unit 103 sends the access request to the memory 150, which is sent from the processor 101 via the sixth channel, to the memory 150 via the fourth channel. In this case, the memory-access control unit 103 applies, according to control information set in advance, restriction on the access request sent to the memory 150.

It is possible to realize the control information set in the memory-access control unit 103 in various forms. For example, a plurality of pairs of <start address, end address> is set. An address of an access request to the memory 150 is within a range of addresses represented by the sets, the memory-access control unit 103 sends the access request to the fourth channel. The memory-access control unit 103 makes it possible to edit the sets of the addresses only in the case of the HV mode.

When a mode information signal indicating the HV mode is input to the first HV-area protecting circuit 104, the memory-access control unit 103 permits access to an address for writing and reading of the control information. When a mode information signal indicating a mode other than the HV mode is input to the first HV-area protecting circuit 104, the memory-access control unit 103 does not permit access to an address for writing and reading of the control information.

In this embodiment, as paths that connect the processor 101 and the memory-access control unit 103, two paths, namely, the sixth channel and a channel that passes the first channel, the first HV-area protecting circuit 104, and the second channel from the processor 101 are provided. However, this embodiment is not limited to a system LSI including such paths. For example, only the channel that passes the first channel, the first HV-area protecting circuit 104, and the second channel from the processor 101 can be provided.

Writing and reading of the control information are performed only in the HV mode as described above. Thus, in switching an operation to a guest OS, the hypervisor sets control information of the memory-access control unit 103 to be suitable for the guest OS, to which the operation is switched, to make it possible to access only data of a guest OS that operates next.

When the mode information signal indicates that the operation mode is the HV mode, the first control unit 131 performs control for permitting access to the control information held by the memory-access control unit 103 and the device-access control unit 105. When the mode information signal indicates that the operation mode is the normal mode, the first control unit 131 performs control for denying access to the control information held by the memory-access control unit 103 and the device-access control unit 105.

Since the channels are formed as described above, the first HV-area protecting circuit 104 does not have to perform processing for access requests other than writing and reading of the control information in the memory-access control unit 103 and the device-access control unit 105.

The first HV-area protecting circuit 104 receives an access request to an address for writing and reading of the control information in the memory-access control unit 103 from the processor 101. Then, when the mode information signal received from the operation-mode managing circuit 102 has a value indicating the HV mode, the first HV-area protecting circuit 104 outputs the access request to the memory-access control unit 103 via the second channel. When the mode information signal received from the operation-mode managing circuit 102 has a value indicating a mode other than the HV mode, the first HV-area protecting circuit 104 prevents the access request from being output to the memory-access control unit 103.

In this embodiment, data transmission and reception for an access request to the control information of the memory-access control unit 103 is performed via the first channel and the second channel. Data transmission and reception for an access request to information other than the control information of the memory-access control unit 103 is performed via the sixth channel. However, these separate channel may be formed as one channel that passes the first HV-area protecting circuit 104. In this case, an access request to the memory 150 is also performed via the first HV-area protecting circuit 104. The first HV-area protecting circuit 104 performs the above-mentioned control for writing and reading of the control information of the memory-access control unit 103. However, the first HV-area protecting circuit 104 outputs all other access requests (e.g., an access request to the memory 150) to the memory-access control unit 103.

The device-access control unit 105 controls access to the device 160. As with the memory-access control unit 103, the device-access control unit 105 receives an access request to control information held by the device-access control unit 105 via the first HV-area protecting circuit 104. Since processing performed by the device-access control unit 105 is the same as that performed by the memory-access control unit 103, an explanation of the processing is omitted.

It is possible to realize the control information set in the device-access control unit 105 in various forms. For example, a plurality of pairs of <start address, end address> is set. An address of an access request to the device 160 is within a range of addresses represented by the sets, the device-access control unit 105 sends the access request to the fifth channel. The device-access control unit 103 makes it possible to edit the sets of the addresses only in the case of the HV mode.

As another form of the control information, when a plurality of devices is connected to the system LSI 100, pairs of <start address, end address> corresponding to the respective devices may be set in advance and an indication on whether access to the addresses is permitted may be set as a bit mask of one bit. In this form, when an address of an access request to a device is within a range of the addresses assigned to the devices corresponding to the bit mask “1”, the access request is output.

In this embodiment, for example, when a guest OS is switched, since the hypervisor rewrites the control information of the device-access control unit 105, it is possible to permit only a device allocated to a guest OS in operation to access the control information.

Operations performed by the operation-mode managing circuit 102 are roughly divided into the following two operations.

As a first operation, the operation-mode managing circuit 102 checks an HV-mode entry when the operation mode is the normal mode. When the predetermined conditions are satisfied, the operation-mode managing circuit 102 causes the operation mode to transit to the HV mode. As a second operation, the operation-mode managing circuit 102 checks an HV-mode exit when the operation mode is the HV mode. When the predetermined conditions are satisfied, the operation managing circuit causes the operation mode to transition to the normal mode.

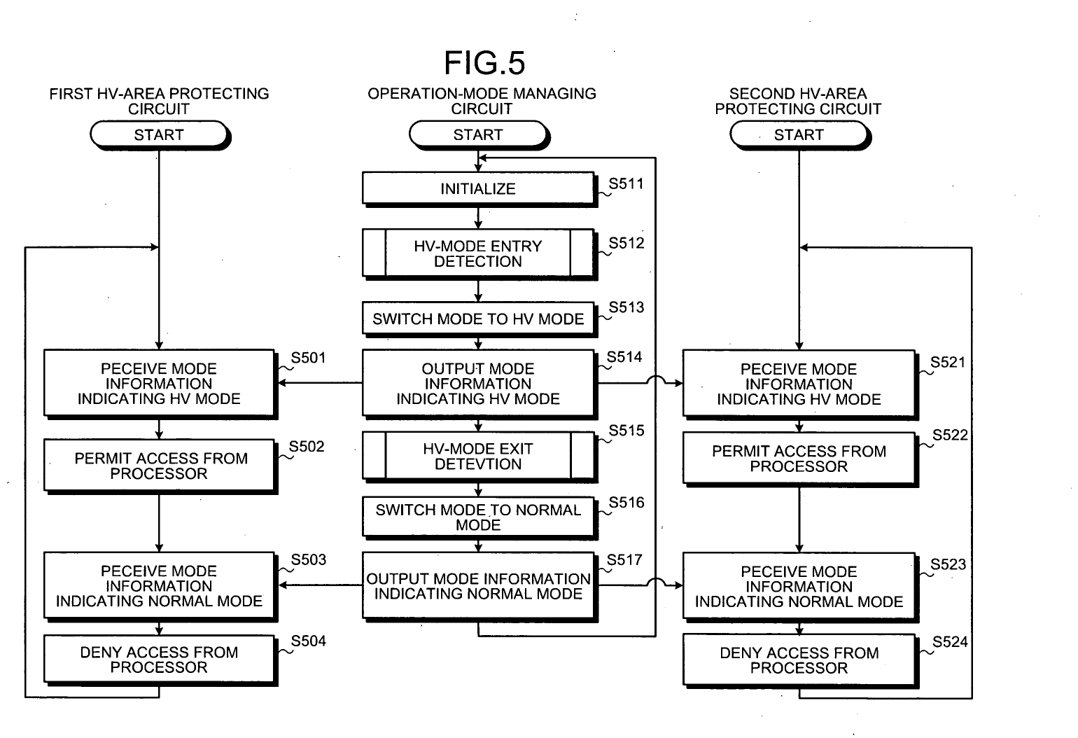

As shown in FIG. 5, first, the operation-mode managing circuit 102 performs initialization when the entire system LSI 100 is started (step S511). The operation-mode managing circuit 102 sets the operation mode in the normal mode.

Thereafter, the detecting unit 121 of the operation-mode managing circuit 102 monitors the first channel and detects an HV-mode entry (step S512). The detecting unit 121 monitors the first channel and checks the first channel until the predetermined conditions are satisfied. A detailed processing procedure of HV-mode entry detection is described later.

The mode switching unit 122 switches the operation mode to the HV mode (step S513). The operation-mode managing circuit 102 outputs a mode information signal indicating that the operation mode is the HV mode to the first HV-area protecting circuit 104 and the second HV-area protecting circuit 106 (step S514). While, in FIG. 5, the mode information signal is output at this timing for simplicity of explanation, the operation-mode managing circuit 102 outputs the mode information signal at regular intervals. The operation-mode managing circuit 102 can always output the mode information signal to the control lines. In any case, the operation-mode managing circuit 102 is capable of communicating timing of mode change to the first HV-area protecting circuit 104 and the second HV-area protecting circuit 106. The first operation is as described above.

The first HV-area protecting circuit 104 receives the mode information signal from the operation-mode managing circuit 102 and recognizes that the operation mode has been changed to the HV mode (step S501). Consequently, the first control unit 131 permits access to the control information held by the memory-access control unit 103 and the device-access control unit 105 (step S502).

Similarly, upon receiving the mode information signal from the operation-mode managing circuit 102, the second HV-area protecting circuit 106 recognizes that the operation mode has been changed to the HV mode (step S521). Consequently, the second control unit 132 permits access to the protection memory 107 (step S522).

Thereafter, the detecting unit 121 of the operation-mode managing circuit 102 monitors the first channel and detects an HV-mode exit (step S515). The detecting unit 121 monitors the first channel and checks the first channel until the predetermined conditions are satisfied. A detailed processing procedure of HV-mode exit detection is described later.

The mode switching unit 122 performs switches the operation mode to the normal mode (step S516). The operation-mode managing circuit 102 outputs a mode information signal indicating that the operation mode is the normal mode to the first HV-area protecting circuit 104 and the second HV-area protecting circuit 106 (step S517). The second operation is as described above.

Upon receiving the mode information signal from the operation-mode managing circuit 102, the first HV-area protecting circuit 104 recognizes that the operation mode has been changed to the normal mode (step S503). Consequently, the first control unit 131 denies access to the control information held by the memory-access control unit 103 and the device-access control unit 105 (step S504).

Similarly, upon receiving the mode information signal from the operation-mode managing circuit 102, the second HV-area protecting circuit 106 recognizes that the operation mode has been changed to the normal mode (step s523). Consequently, the second control unit 132 denies access to the protection memory 107 (step S524).

In this embodiment, it is possible to appropriately protect the components stored in the HV protection area according to the operation mode.

A processing procedure of the HV-mode entry detection at step S512 in FIG. 5 is explained below. As an HV-mode entry check, there is a plurality of forms corresponding to combinations with the entry section of the HV code. In this embodiment, one form among the forms is explained. Examples of the other forms are explained in embodiments described later.

A method of checking the HV-mode entry according to this embodiment is a method of checking interrupt disabled in the entry section of the HV code. The HV code is explained in detail below.

As shown in FIG. 3, a store instruction for writing a state of the processor 101 in a predetermined address is present in a starting address (HVEntry) in which the HV code is stored. In this embodiment, this instruction is the entry section of the HV code. This instruction is equivalent to one instruction of a machine language provided by the processor 101.

“SR” included in this instruction indicates a register (a status register) that stores therein a value indicating the state of the processor 101. A value of “SR” contains information indicating whether the processor 101 is currently in an interrupt disable state is included in.

“CheckAdr” included in this instruction is an address to which the value of “SR” is written. As “CheckAdr”, it is desirable to select an address actually not present and different from addresses of the memories and the devices controlled by the processor 101. In this case, although the processor 101 sends an access request to the channels, the memories and the devices connected via the channels do not actually perform reading and writing in response to the access request.

When an address actually present is selected as “CheckAdr”, it is necessary to select an address not used by all programs including the hypervisor and the guest OSs. If a device is present in the address indicated by “CheckAdr”, data writing processing is performed according to the instruction. As a result, it is likely that malfunction of the device is caused. Therefore, it is necessary to be careful not to select an address actually used.

When the entry section of the HV code is executed, a signal is sent from the processor 101 to the first channel in the following order.

As first processing, the processor 101 sends a instruction-fetch request to the address “HVEntry” in the HV-code storage area 112. As second processing, the HV-code storage area 112 sends data (a instruction in HVEntry) to the processor 101 according to the request.

As third processing, the processor 101 sends a request for writing of data (a value indicating a processor state) to the address “CheckAdr”.

The operation-mode managing circuit 102 checks the first processing to guarantee that execution is shifted to the entry section of the HV code. The operation-mode managing circuit 102 checks the third processing to guarantee that the processor 101 is in an interrupt disable state. However, in the third processing, the data (the value indicating the processor state) needs to indicate that the processor 101 is in the write inhibit state. According to the guarantees, conditions for the operation-mode managing circuit 102 to cause the operation mode to transition to the HV mode are satisfied.

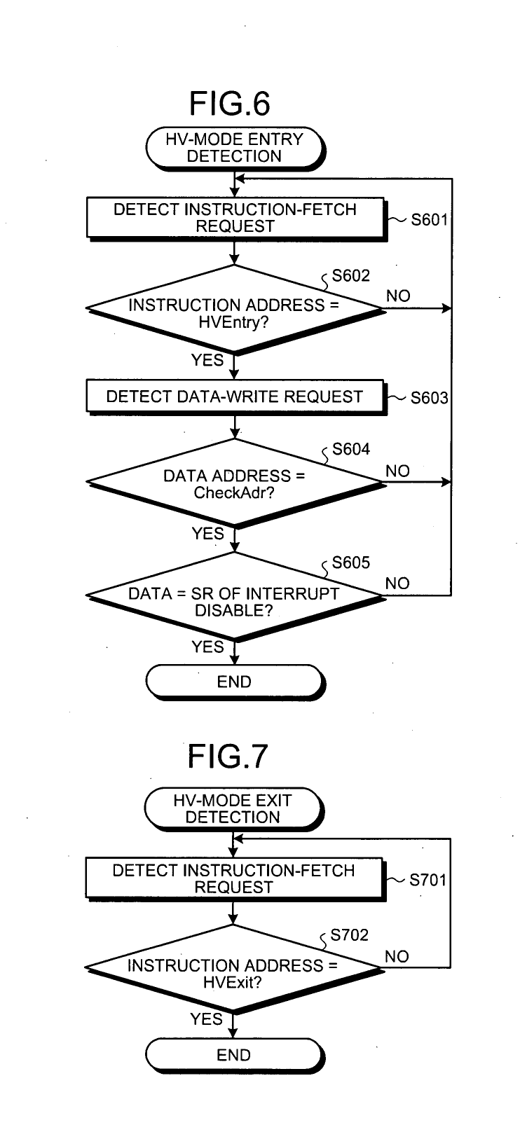

As shown in FIG. 6, first, the detecting unit 121 monitors the first channel and detects a instruction-fetch request sent from the processor 101 (step S601).

When the instruction-fetch request is detected, the detecting unit 121 judges whether an address designated by the instruction-fetch request matches “HVEntry” (step S602). When the address does not match “HVEntry” (No at step S602), the detecting unit 121 detects a instruction-fetch request again (step S601).

When the address matches “HVEntry” (Yes at step S602), the detecting unit monitors the first channel and detects a data-write request sent from the protection memory 107 (step S603).

When the data-write request is detected, the detecting unit 121 judges whether an address designated by the data-write request matches “CheckAdr” (step S604). When the address does not match “CheckAdr” (No at step S604), the detecting unit 121 detects a instruction-fetch request again (step S601).

When the address matches “CheckAdr” (Yes at step S604), the detecting unit 121 judges whether data designated by the data-write request and a value of “SR” indicating interrupt disable match each other (step S605). When the data and the value mismatch (No at step S605), the detecting unit 121 detects a instruction-fetch request again (step S601).

When the data and the value of “SR” indicating interrupt disable match each other (Yes at step S605), the detecting unit 121 determines that an HV-mode entry check has been completed. Then, the processing from step S513 shown in FIG. 5 is performed.

When “SR” indicates only interrupt disable/enable, the entire write data only has to be simply compared. However, in general, a register indicating a processor state often indicates different states such as an interrupt state, an address translation mode, and a privilege mode in a unit of bit. In such a case, only a bit corresponding to an interrupt state has to be compared.

A processing procedure of the HV-mode exit detection at step S515 in FIG. 5 is explained below. As a check for the HV-mode exit, an example of an HV-mode exit corresponding to the HV-mode entry check is explained. In the following example, as a first form of the check of the HV-mode exit, the operation mode is caused to transition to the normal mode when execution of a instruction with which it is guaranteed that processing that should be performed in the HV mode is finished (hereinafter, “HV-mode exit instruction).

The instruction with which it is guaranteed that processing that should be performed in the HV mode is finished depends on the HV code. Therefore, as the instruction, there are various forms according to HV codes. For example, in the HV code shown in FIG. 3, when a last instruction “return” of the HV code indicated by reference sign 302 is invoked, the processing according to the HV code is finished. Thus, when the processor 101 invokes the last instruction 302 and switches software to be executed to a guest OS, processing after this does not have to be performed in the HV mode. Thus, in the HV code shown in FIG. 3, the last instruction 302 is used as the HV-mode exit instruction. In this embodiment, the HV-mode exit instruction is not restricted to the last instruction of the HV code. In other words, the HV-mode exit instruction may be a instruction before the last instruction of the HV code as long as the instruction is the instruction with which it is guaranteed that processing that should be performed in the HV mode is finished.

When the HV-mode exit instruction (the last instruction 302) shown in FIG. 3 is executed, first, the processor 101 sends a instruction-fetch request to an address (hereinafter, “HVExit”) of the protection memory 107 in which the HV-mode exit instruction is stored. Subsequently, data stored in the HV-code storage area 112 (a instruction stored in “HVExit”) is sent from the protection memory 107 to the processor 101.

In this embodiment, when fetch for the address at which the HV-mode exit instruction is stored is detected, the operation-mode managing circuit 102 judges that it is guaranteed that the processing that should be performed in the HV mode is finished and switches the operation mode to the normal mode.

As shown in FIG. 7, first, the detecting unit 121 monitors the first channel and detects a instruction-fetch request sent from the processor 101 (step S701).

When the instruction-fetch request is detected, the detecting unit 121 judges whether an address designated by the instruction-fetch request matches “HVExit” (step S702). When the address does not match “HVExit” (No at step S702), the detecting unit 121 detects a instruction-fetch request again (step S701).

When the address designated by the instruction-fetch request matches “HVExit” (Yes at step S702), the detecting unit 121 determines that an HV-mode exit check is completed. Then, the processing from step S516 shown in FIG. 5 is performed.

As a method of restricting the HV protection area, a restriction method other than that described in this embodiment can be used. For example, in the case of the operation mode other than the HV mode, all kinds of operation (reading and writing) for all addresses of all the memories and devices stored in the HV protection area may be denied. As another example, access to and writing in only a part of the addresses stored in the HV protection area may be denied. These restrictions may be combined.

When a signal for distinguishing instruction fetch from data reading is not present in data transmitted through the channels, it is necessary to input a signal indicating the instruction fetch to the operation-mode managing circuit through a path separate from the channels. This makes it possible to distinguish the instruction fetch from the data reading.

By using the system LSI 100, it is possible to secure a protection area accessible only at the time of execution of the HV code without relying on a virtualization support function of the processor. By storing information such as access control information of the memories and the devices, management information of the guest OSs, and the HV code body, it is possible to prevent the guest OSs from illegally reading and writing the information. It is possible to improve safety by surely realizing isolation among the guest OSs.

The first embodiment is susceptible of various modifications. Some examples are described below.

In the first embodiment, the operation-mode managing circuit 102 manages two operations modes, i.e., the HV mode and the normal mode. However, the operation modes are not limited to them. As a first modification of the first embodiment, there can be three operation modes.

In the first modification of the first embodiment, an HV-mode entry check the same as that in the first embodiment is applied. Thus, it is necessary to perform processing for standing by for detection of a instruction for data writing after instruction fetch sent from the processor 101 is detected.

Thus, when the operation-mode managing circuit is implemented as a state transition circuit taking the above into account, a state of monitoring for detection of instruction fetch (HVEntry) is set as a normal mode 1, a state of standby for data writing is set as a normal mode 2, and a state of standby for instruction fetch (an HV-mode exit instruction) is set as an HV mode.

When the operation-mode managing circuit is implemented as the state transition circuit having the three states in this way, it is desirable to output “0” in the normal mode 1 and the normal mode 2, output “1” in the HV mode, and an identical signal in the modes other than the HV mode as a mode information signal output by the operation-mode managing circuit.

Otherwise, processing are the same as that previously described in the first embodiment, and the same explanations are not repeated.

In the first embodiment, the first HV-area protecting circuit 104, the memory-access control unit 103, the device-access control unit 105, the second HV-area protecting circuit 106, and the protection memory 107 are included in the HV protection area. However, components included in the HV protection area are not limited to these devices.

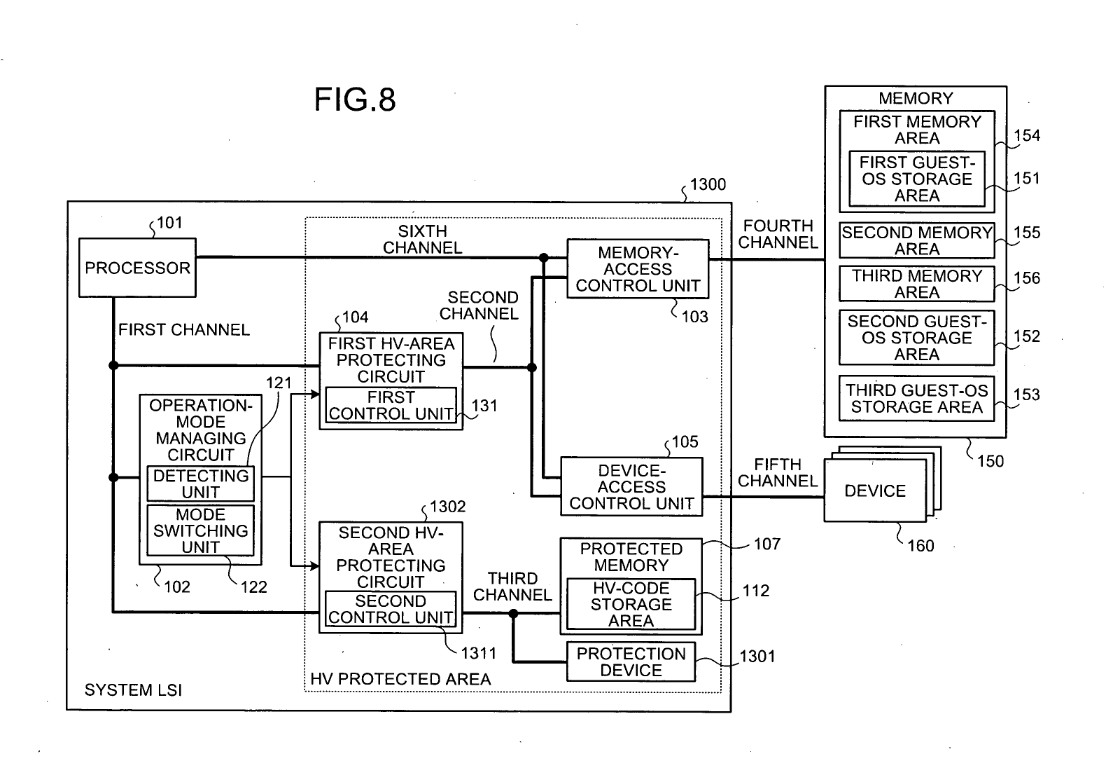

FIG. 8 is a block diagram of a system LSI 1300 according to the second modification of the first embodiment. The system LSI 1300 is basically similar to the system LSI 100 except for a second HV-area protecting circuit 1302 and a protection device 1301. The second HV-area protecting circuit 1302 performs processing different from that performed by the second HV-area protecting circuit 106. The protection device 1301 is included in the HV protection area.

The protection device 1301 receives a request from the processor 101 via the second HV-area protecting circuit 1302 in the same manner as the protection memory 107.

In this modification, the processor 101 and the second HV-area protecting circuit 1302 are connected by the first channel and the second HV-area protecting circuit 1302 and the protection device 1301 are connected by the third channel. A mode information signal from the operation-mode managing circuit 102 is input to the second HV-area protecting circuit 1302.

The second HV-area protecting circuit 1302 includes a second control unit 1311. The second HV-area protecting circuit 1302 is different from the second HV-area protecting circuit 106 in that the second HV-area protecting circuit 1302 controls not only access to the protection memory 107 but also access to the protection device 1301. Otherwise, processing of the second HV-area protecting circuit 1302 are the same as that of the second HV-area protecting circuit 106, and the same explanations are not repeated.

Upon receipt of input that indicates the operation mode is the HV mode, the second control unit 1311 performs control for permitting an access request to the protection memory 107 and the protection device 1301.

The second HV-area protecting circuit 1302 applies restrictions peculiar to respective HV protection areas to an access request when the operation mode is the modes other than the HV mode. Therefore, the second HV-area protecting circuit 1302 prevents the access request denied by the restrictions from being output to the protection device 1301.

This modification is effective in protecting devices that should not be directly operated by the guest OSs. For example, since an interval timer, an interrupt controller, and the like are generally controlled by a plurality of guest OSs, the guest OSs should not directly access the devices. In controlling the devices, the hypervisor once receives control requests for the devices and controls the devices in a procedure that do not cause deficiency. Safety is improved by performing processing in such a procedure.

In the system LSI 100, the HV-code storage area is provided in the protection memory 107 in the HV protection area. However, the HV-code storage area may be provided in, for example, a memory connected to a system LSI. Thus, in a second embodiment of the present invention, the HV-code storage area is provided in the memory connected to the system LSI. Other forms of the HV-mode entry and the HV-mode exit are also explained.

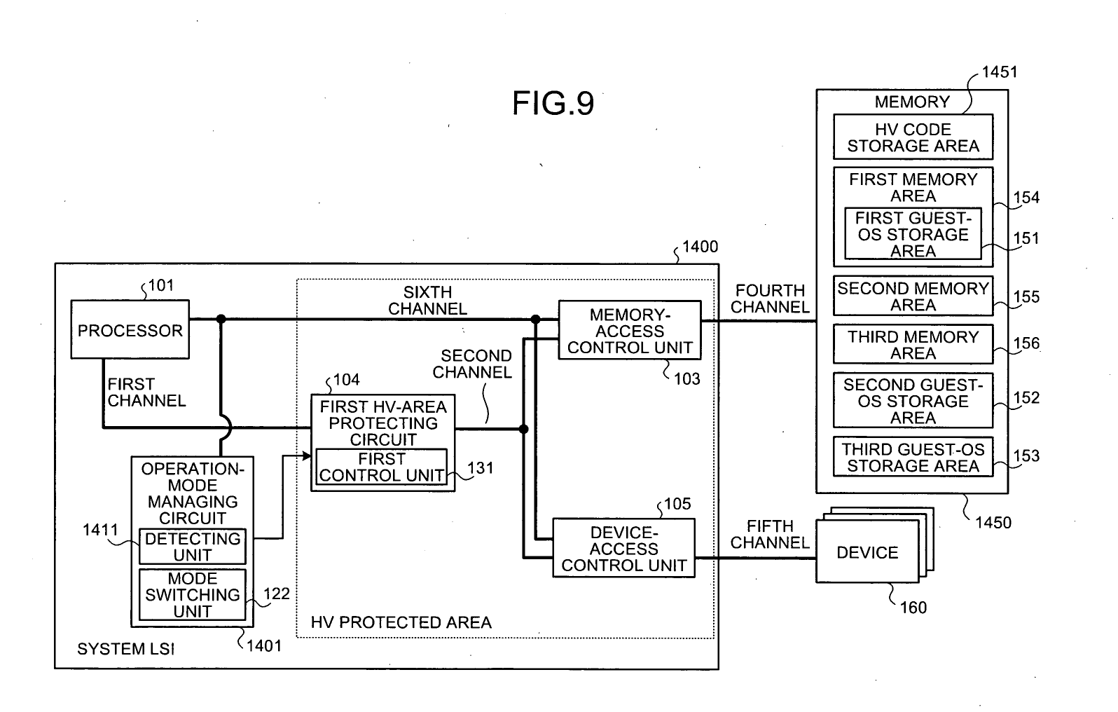

FIG. 9 is a block diagram of a system LSI 1400 according to the second embodiment. The system LSI 1400 is basically similar to the system LSI 100 except that the second HV-area protecting circuit 106 and the protection memory 107 are deleted. Besides, the system LSI 1400 includes a memory 1450 that stores information different from that stored in the memory 150, and an operation-mode managing circuit 1401 that performs processing different from that performed by the operation-mode managing circuit 102. In FIG. 9, like reference numerals refer to portions corresponding to those in the system LSI 100, and the same explanations are not repeated.

In the memory 1450, an HV-code storage area 1451 is provided in addition to the storage areas of the memory 150. When the operation mode is the normal mode, writing in the HV-code storage area 1451 is also denied according to the control by the memory-access control unit 103. The HV code itself performs setting of control information that designates write protection for the HV-code storage area 1451.

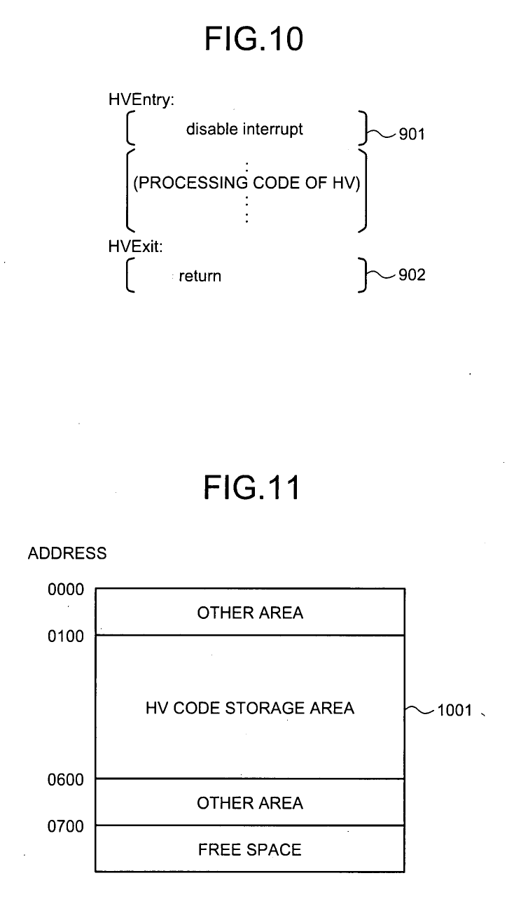

The HV-code storage area 1451 stores the HV code. As shown in FIG. 10, the HV code holds “disable interrupt” in an entry section 901 and holds “return” in an exit section 902.

As shown in FIG. 11, an HV-code storage area 1001 is stored among addresses 0100 to 0600. Although not shown on FIG. 11, the first guest-OS storage area 151 and the like are also arranged on the memory 1450. Consequently, when a request for fetch to addresses other than the addresses 0100 to 0600 is received, it is possible to judge that processing exits the HV code and is switched to the first guest OS or the like.

The operation-mode managing circuit 1401 includes a detecting unit 1411 and the mode switching unit 122. The operation-mode managing circuit 1401 monitors data transmitted through the sixth channel, which connects the processor 101 and the memory access control unit 103, and switches the operation mode as required.

The detecting unit 1411 detects, for example, fetch of a instruction for a predetermined address of the HV code stored in the HV-code storage area 1451 of the memory 1450 via the sixth channel, which connects the processor 101 and the memory-access control unit 103. Detailed processing is described later.

The system LSI 1400 performs setting of control information corresponding to transition of the operation mode according to the processing procedure shown in FIG. 5 in the same manner as the system LSI 100. However, processing performed by the system LSI 1400 is different from that performed by the system LSI 100 only in detection of an HV-mode entry at step S512 and detection of an HV-mode exit at step S515 performed by the detecting unit 1411. Thus, a detection processing procedure performed by the detecting unit 1411 is explained below.

In this embodiment, an interrupt disable state is set in the entry section of the HV code. In other words, in the HV code shown in FIG. 10, a instruction (disable interrupt) for disabling an interrupt is described in a starting address (HVEntry) in which the HV code is stored. This instruction is the entry section of the HV code. This instruction is equivalent to one instruction of a machine language provided by the processor.

When the entry section of the HV code is executed, first, the processor 101 sends a instruction-fetch request to an address “HVEntry” of the HV-code storage area 1451 of the memory 1450 via the sixth channel. The memory 1450 having received the instruction-fetch request sends data (a instruction in “HVEntry”) from the HV-code storage area 1451.

When the operation-mode managing circuit 1401 confirms the instruction-fetch request for “HVEntry” in the sixth channel, the operation-mode managing circuit 1401 guarantees that execution is shifted to the entry section of the HV code and guarantees that the entry section is in the interrupt disable state. It is possible to guarantee that the entry section is in the interrupt disable state because the instruction for disabling an interrupt is included in the starting address as described above. Consequently, the operation-mode managing circuit 1401 can judge that the conditions for causing the operation mode to transition to the HV mode have been satisfied.

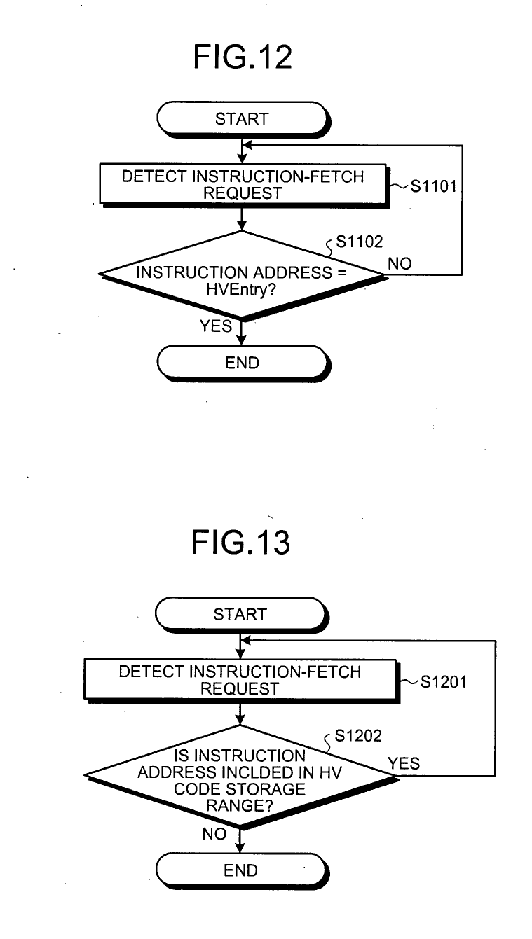

As shown in FIG. 12, first, the detecting unit 1411 monitors the sixth channel and detects a instruction-fetch request sent from the processor 101 (step S1101).

When the instruction-fetch request is detected, the detecting unit 1411 judges whether an address designated by the instruction-fetch request matches “HVEntry” (step S1102). When the address does not match “HVEntry” (No at step S1102), the detecting unit 1411 detects a instruction-fetch request again (step S1101).

When the address matches “HVEntry” (Yes at step S1102), the detecting unit 1411 determines that an HV-mode entry check is completed. Then, the processing from step S513 shown in FIG. 5 is performed.

In this embodiment, the detecting unit 1411 judges that the operation mode has exited the HV mode when fetch of a instruction other than the HV code is detected.

As shown in FIG. 13, first, the detecting unit 1411 monitors the sixth channel and detects a instruction-fetch request from the processor 101 (step S1201).

When the instruction-fetch request from the processor 101 is detected, the detecting unit 1411 judges whether an address designated by the request is included in a range of addresses at which the HV code is stored (step S1202). In the example shown in FIG. 11, the detecting unit 1411 judges whether the address is included in the range of the addresses 0100 to 0600, which is the HV-code storage area. When the address is included in the range (No at step S1202), the detecting unit 1411 detects a instruction-fetch request from the processor 101 again (step s1201).

When the address designated by the instruction-fetch request is not included in the range (Yes at step S1202), the detecting unit 1411 judges that an HV-mode exit check is completed. Then, the processing from step S516 shown in FIG. 5 is performed.

In the processing procedure of HV-mode exit detection according to this embodiment, even when there is deficiency in the HV code itself or even when a security hole of the HV code is found in future, it is possible to prevent processing from being jumped to a guest OS from the middle of the HV code to execute the guest OS while the HV mode is maintained.

To simplify a comparator for a instruction address in this embodiment, as shown in FIG. 11, it is desirable that the HV code is present the continuous addresses in the HV-code storage area 1451 in the memory 1450. This is because, when the HV code and programs other than the HV code are alternately present on addresses of the memory 1450, an address range that should be compared is complicated and the comparator is complicated.

The method of detecting HV exit is adopted only when a channel that connects the memories in which programs and the like are stored and the processor is one route and it is possible to monitor all accesses to the memories from the processor 101. If there is a plurality of channels connected to the processor 101 and a memory that stores a code of a guest OS and a memory that stores the HV-code storage area are connected to different channels (e.g., the first embodiment), it is impossible to monitor a request for fetching a instruction of the code of the guest OS in the operation-mode managing circuit. Thus, the guest OS is executed while the HV mode is maintained. Therefore, when such channels are adopted, it is impossible to apply the method of detecting HV exit.

In the configuration of the system LSI 1400, the operation mode can be switched by the detection method described in the first embodiment. In the first embodiment, the stored HV-code storage area is arranged in the protection memory 107 connected via the first path and the guest OSs and the like are arranged in the memory 150 connected via the sixth channel. Thus, the operation-mode managing circuit 102 cannot detect an access request to the memory. Therefore, in the configuration described in the first embodiment, it is impossible to switch the operation mode using the method of detecting HV code exit described in the second embodiment.

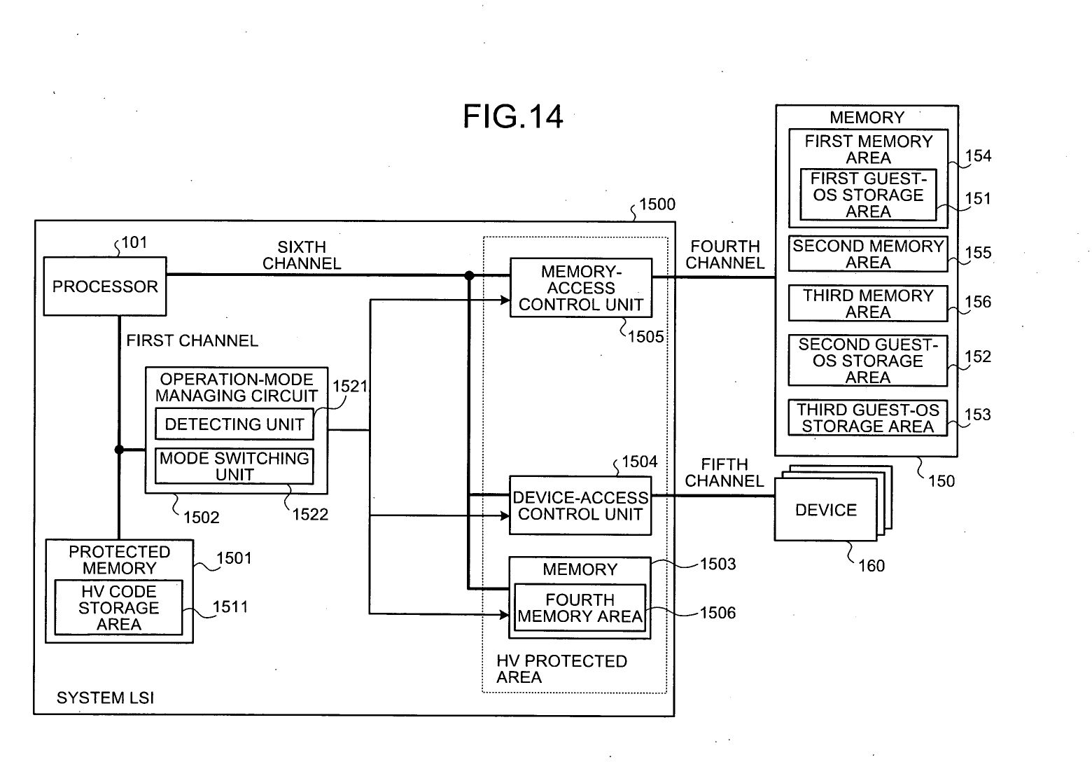

FIG. 14 is a block diagram of a system LSI 1500 as a modified example. A protection memory having an HV-code storage area and the processor 101 are directly connected by the first channel.

As shown in FIG. 14, the system LSI 1500 is basically similar to the system LSI 100 except for an operation-mode managing circuit 1502, a protection memory 1501, a memory-access control unit 1505, a device-access control unit 1504, and a memory 1503. Besides, the first HV-area protecting circuit 104 and the second HV-area protecting circuit 106 are deleted. The operation-mode managing circuit 1502 performs processing different from that performed by the operation-mode managing circuit 102. The protection memory 1501 is arranged differently from the protection memory 107. The memory-access control unit 1505 performs processing different from that performed by the memory-access control unit 103. The device-access control unit 1504 performs processing different from that performed by the device-access control unit 105. In FIG. 14, like reference numerals refer to portions corresponding to those in the system LSI 100, and the same explanations are not repeated.

The protection memory 1501 is a memory that is not stored in the HV protection area and can be freely referred to from the processor 101. The protection memory 1501 is a ROM that is not writable from the processor 101. This makes it possible to prevent correction by a guest OS. Since an HV code stored in an HV-code storage area 1511 is the same as the HV code shown in FIG. 3 in the first embodiment, an explanation of the HV code is omitted. If it is possible to prevent rewriting of the HV code as in this modified example, the HV-code storage area may be present outside the HV protection area.

The operation-mode managing circuit 1502 includes a detecting unit 1521 and a mode switching unit 1522. As in the first embodiment, the operation-mode managing circuit 1502 monitors data transmitted through the first channel, which connects the processor 101 and the protection memory 1501, and switches the operation mode as required. Since a method of switching the operation mode is the same as the method in the first embodiment, an explanation of the method is omitted.

In the system LSI 1500, the memory-access control unit 1505, the device-access control unit 1504, and the memory 1503 are stored in the HV storage area.

The memory-access control unit 1505, the device-access control unit 1504, and the memory 1503 have functions equivalent to the HV storage protecting circuit in the insides thereof, respectively. Consequently, the memory-access control unit 1505, the device-access control unit 1504, and the memory 1503 can control access according to the operation mode.

Since the memory-access control unit 1505, the device-access control unit 1504, and the memory 1503 are the same as the memory-access control unit 103, the device-access control unit 105, and the protection memory 107 (excluding the HV-code storage area 112), explanations of the devices are omitted.

The memory 1503 includes a fourth memory area 1506. The memory 1503 protects information stored in the fourth memory area 1506 with the function equivalent to the HV area protection circuit.

In this way, even if the HV-code storage area 112 is present outside the HV protection area, it is possible to ensure safety according to switching of the operation mode as in the first embodiment.

As described above, according to an embodiment of the present invention, access from a guest OS can be controlled regardless of whether a processor has a virtualization support function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a storage unit that stores therein first software that is allowed to access a first access range;
a processor that executes the first software and second software that is allowed to access a second access range narrower than the first access range;
a channel for communicating data to execute the first software on the processor, the channel connecting the storage unit and the processor;
a detecting unit that detects a fetch request that is issued by the processor through the channel and specifies a storage address in the storage unit at which the first software is stored; and
a control unit that controls an access range of the processor based on whether the fetch request is detected.

2. The apparatus according to claim 1, wherein
the storage address is a starting address indicating start of the first software, and
the control unit changes the access range of the processor from the second access range to the first access range when the fetch request is detected.

3. The apparatus according to claim 1, wherein
the detecting unit further detects that interrupt is disabled on the processor, and
the control unit permits the processor to access the first access range when the fetch request is detected and interrupt is disabled.

4. The apparatus according to claim 1, wherein the control unit permits writing to a memory address in the access range of the processor when the fetch request is detected.

5. The apparatus according to claim 1, wherein
the first access range includes the storage address, and
the control unit permits the processor to access the first access range when the fetch request is detected.

6. The apparatus according to claim 1, wherein
the detecting unit further detects a write instruction issued by the processor, and
the control unit controls the access range of the processor based on whether the write instruction specifies an address for check and a value contained in the write instruction indicates interrupt disable.

7. The apparatus according to claim 1, wherein the storage address is an address at which a instruction to disable interrupt to the processor is stored.

8. The apparatus according to claim 1, wherein
the detecting unit further detects an exit instruction that guarantees that the storage address is not to be accessed, and
the control unit changes the access range of the processor from the first access range to the second access range when the exit instruction is detected.

9. The apparatus according to claim 1, wherein
the detecting unit detects whether the fetch request specifies the storage address, and
the control unit changes the access range of the processor from the first access range to the second access range when the fetch request specifies an address different from the storage address.

10. The apparatus according to claim 1, wherein the control unit changes an accessible area of a data storage unit in the access range of the processor.

11. The apparatus according to claim 1, wherein the control unit changes an accessible device included in the access range.

12. The apparatus according to claim 1, further comprising an access control unit that controls access to a data storage unit based on control information that indicates whether access to a storage area of the data storage unit is permitted with respect to the second software, wherein
the control unit allows the processor to perform writing to the control information when the fetch request is detected.

13. The apparatus according to claim 1, further comprising an access control unit that controls access to a device based on control information that indicates whether access to the device is permitted with respect to the second software, wherein
the control unit allows the processor to perform writing to the control information when the fetch request is detected.
